(19) United States
(12) Patent Application Publication
(10) Pub. No.: US 2012/0052324 A1
(43) Pub. Date: Mar. 1, 2012

(54) Electric Al-Zr-Mn Alloy-Plating Bath Using Room Temperature Molten Salt Bath, Plating Method Using the Same and Al-Zr-Mn Alloy-Plated Film

(75) Inventors: Manabu Inoue, Tokyo (JP); Tadahiro Ohnuma, Tokyo (JP); Tsutomu Miyadera, Wako-shi (JP)

(73) Assignees: HONDA MOTOR CO., LTD., Tokyo (JP); DIPSOL CHEMICALS CO., LTD., Tokyo (JP)

(21) Appl. No.: 12/871,365

(22) Filed: Aug. 30, 2010

(51) Int. Cl. B32B 15/01; B32B 15/04; C25D 5/18; C25D 3/66; C25D 3/44

(52) U.S. Cl. 428/653; 205/232; 205/236; 205/104; 205/50

(57) ABSTRACT

Provided herein is an electric Al—Zr—Mn alloy-plating bath which comprises (A) an aluminum halide; (B) one or at least two kinds of compounds selected from the group consisting of N-alkylpyridinium halides, N-alkylimidazolium halides, N,N′-dialkyl-imidazolium halides, N-alkyl-pyrazolium halides, N,N′-dialkyl-pyrazolium halides, N-alkylpyrrolidinium halides and N,N-dialkyl-pyrrolidinium halides; (C) a zirconium halide; and (D) a manganese halide, in which the molar ratio of the aluminum halide (A) to the compound (B) ranges from 1:1 to 3:1. The plating bath never involves any risk of causing an explosion and can provide a smooth and fine Al—Zr—Mn alloy-plated film. Moreover, the resulting film has high resistance to corrosion even when it does not contain any chromium and therefore, it is quite suitable from the viewpoint of the environmental protection and it can thus be used in a wide variety of applications including the plating of parts for motorcars, and the plating of parts for electrical appliances.

### BACKGROUND OF THE INVENTION

1. Field of the Invention

The present invention relates to an electric Al—Zr—Mn alloy-plating bath which can be used at ordinary temperature. More particularly, the present invention relates to an electric Al—Zr—Mn alloy-plating bath for forming an electric Al—Zr—Mn alloy-plated layer, which can be used as a usual surface treatment for the prevention of the occurrence of any corrosion.

2. Brief Description of the Related Art

It has been well-known that an aluminum metal material shows excellent anti-corrosive properties, but aluminum has a strong affinity for oxygen and the reduction potential thereof is inferior to that of hydrogen. For this reason, the electro-deposition of an aluminum layer from an aqueous solution containing the same is quite difficult. Therefore, the electro-plating of aluminum has long been put into practice while using an organic solvent-based plating bath or a high temperature molten salt bath. Typical examples of such organic solvent-based plating baths include those obtained by dissolving AlCl₃ and LiAlH₄ or LiH in ether; those obtained by dissolving these components in tetrahydrofuran; and solutions of NaF.2Al(C₂H₅)₃ in toluene. However, these baths suffer from a problem such that the handling thereof is quite difficult, since it may involve a risk of causing an explosion when it is brought into contact with the air or water. Thus, there has been proposed a mixed molten salt bath comprising an aluminum halide and an alkylpyridinium halide as a bath free of any risk of causing an explosion (see Patent Document 1 specified below). Moreover, there has also been proposed a molten salt bath comprising an aluminum halide and an alkyl imidazolium halide, which is further blended with a zirconium halide (see Non-patent Document 1 specified below). However, the plating of aluminum from such an Al—Zr alloy plating bath results in the formation of an electro-deposited layer which is non-uniform and insufficient in the smoothness. In particular, when increasing the thickness of the plated layer and/or when increasing the current density, a problem arises such that a dendritic deposit is formed at high current density portions and the deposit thus formed is easily peeled off from the surface of a substrate. Contrary to this, when reducing the current density used, another problem arises such that the throwing power is reduced and this accordingly results in the formation of areas free of any deposit layer. Moreover, if the resulting plated film is subjected to, for instance, the salt spray test without subjecting the film to a chromate-treatment which makes use of chromium (VI)-containing compound, the film is easily dissolved in the salt solution, never ensures the expected anti-corrosive power and accordingly, it would be quite difficult to obtain a highly anti-corrosive Al alloy-plated film.

Patent Document 1: JP-A-62-70592

Non-patent Document 1: Journal of The Electrochemical Society, 2004, 151(7), C447-C454 (2004).

### SUMMARY OF THE INVENTION

Accordingly, it is an object of the present invention to provide an electric Al—Zr—Mn alloy-plating bath which never involves any risk of causing an explosion even when it comes in close contact with the air or water, which is never accompanied by the formation of any dendritic deposit even at high current density portions, which can ensure the excellent throwing power and form a smooth and uniform plated film even on the low current density area and which can also provide a plated film having high corrosion resistance even when the film is not subjected to any chromate-treatment. It is also an object of the present invention to provide a chromium-free, highly anti-corrosive Al—Zr—Mn alloy-plated film.

The present invention has been completed on the basis of such a finding that the improvement of the corrosion resistance and uniformity of a plated film, as the foregoing object, can be accomplished by forming such a plated film while using a mixed molten bath comprising an aluminum halide and an imidazolium halide, which further comprises a zirconium halide and a manganese halide incorporated into the same. Moreover, the present invention has likewise been completed on the basis of the finding that the uniformity of the resulting plated film and the effect of inhibiting the formation of any dendritic deposit can be further improved by the addition of a specific organic polymer or a combination of a specific organic polymer and a brightening agent. More specifically, the present invention herein provide an electric Al—Zr—Mn alloy-plating bath which comprises (A) an aluminum halide; (B) one or at least two kinds of compounds selected from the group consisting of N-alkylpyridinium halides, N-alkylimidazolium halides, N,N′-dialkyl-imidazolium halides, N-alkylpyrazolium halides, N,N′-dialkyl-pyrazolium halides, N-alkylpyrrolidinium halides and N,N-dialkyl-pyrrolidinium halides; (C) a zirconium halide; and (D) a manganese halide, in which the molar ratio of the aluminum halide (A) to the compound (B) ranges from 1:1 to 3:1.

In addition, the present invention provides an electro-plating method which makes use of the foregoing electric Al—Zr—Mn alloy-plating bath.

Further, the present invention also provides an Al—Zr—Mn alloy-plated film in which the total co-deposition rate of Zr and Mn in the plated film ranges from 1 to 40% by mass.

The plating bath according to the present invention never involves any risk of causing an explosion and can provide a smooth and fine Al—Zr—Mn alloy-plated film. Moreover, the resulting film has high resistance to corrosion even when it does not contain any chromium and therefore, it is quite suitable from the viewpoint of the environmental protection and it can thus be used in a wide variety of applications including the plating of parts for motorcars, and the plating of parts for electrical appliances.

### DESCRIPTION OF THE PREFERRED EMBODIMENTS

The electric Al—Zr—Mn alloy-plating bath of the present invention comprises (A) an aluminum halide; (B) one or at least two kinds of compounds selected from the group consisting of N-alkylpyridinium halides, N-alkylimidazolium halides, N,N′-dialkyl-imidazolium halides, N-alkyl-pyrazolium halides, N,N′-dialkyl-pyrazolium halides, N-alkylpyrrolidinium halides and N,N-dialkyl-pyrrolidinium halides; and (C) a zirconium halide; and (D) a manganese halide.

The aluminum halide (A) used in the present invention is represented by the general formula: AlX₃, wherein X represents a halogen atom such as a fluorine atom, a chlorine atom, a bromine atom or an iodine atom, with a chlorine or bromine atom being preferably used herein. A chlorine atom is most preferably used herein from the economical standpoint.

The N-alkylpyridinium halides used in the present invention as the compound (B) may have an alkyl substituent in the pyridinium skeleton and, for example, can be represented by the following general formula (I):

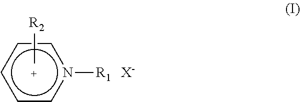

In the formula, R₁ represents a linear, branched or cyclic alkyl group having 1 to 12 carbon atoms and preferably a linear or branched alkyl group having 1 to 5 carbon atoms; R₂ represents a hydrogen atom or a linear, branched or cyclic alkyl group having 1 to 6 carbon atoms and preferably a linear or branched alkyl group having 1 to 3 carbon atoms; and X represents a halogen atom, with a bromine atom being most preferred as the halogen atom, while taking into consideration the reactivity.

Specific examples of such N-alkyl pyridinium halides include N-methylpyridinium chloride, N-methylpyridinium bromide, N-ethyl-pyridinium chloride, N-ethylpyridinium bromide, N-butylpyridinium chloride, N-butylpyridinium bromide, N-hexylpyridinium chloride, N-hexyl-pyridinium bromide, 2-methyl-N-propylpyridinium chloride, 2-methyl-N-propylpyridinium bromide, 3-methyl-N-ethylpyridinium chloride and 3-methyl-N-ethylpyridinium bromide.

The N-alkyl imidazolium halides and N,N′-dialkyl imidazolium halides used in the present invention as the compound (B) may be, for instance, those represented by the following general formula (II);

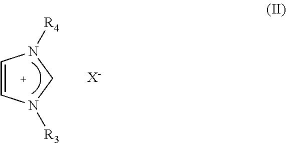

In the formula, R₃ represents a linear, branched or cyclic alkyl group having 1 to 12 carbon atoms and preferably a linear or branched alkyl group having 1 to 5 carbon atoms; R₄ represents a hydrogen atom or a linear, branched or cyclic alkyl group having 1 to 6 carbon atoms and preferably a hydrogen atom or a linear or branched alkyl group having 1 to 3 carbon atoms; and X represents a halogen atom, with a bromine atom being most preferred as the halogen atom, while taking into consideration the reactivity.

Specific examples of the foregoing N-alkyl imidazolium halides and N,N′-dialkyl imidazolium halides include 1-methylimidazolium chloride, 1-methylimidazolium bromide, 1-ethylimidazolium chloride, 1-ethyl imidazolium bromide, 1-propylimidazolium chloride, 1-propylimidazolium bromide, 1-octylimidazolium chloride, 1-octylimidazolium bromide, 1-methyl-3-ethylimidazolium chloride, 1-methyl-3-ethylimidazolium bromide, 1,3-dimethylimidazolium chloride, 1,3-dimethylimidazolium bromide, 1,3-diethyl-imidazolium chloride, 1,3-diethylimidazolium bromide, 1-methyl-3-propylimidazolium chloride, 1-methyl-3-propylimidazolium bromide, 1-butyl-3-butylimidazolium chloride, and 1-butyl-3-butyl imidazolium bromide.

The N-alkylpyrazolium halides and N,N′-dialkyl-pyrazolium halides used in the present invention as the compound (B) are, for instance, those represented by the following general formula (III);

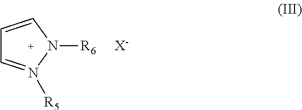

In the formula, R₅ represents a linear, branched or cyclic alkyl group having 1 to 12 carbon atoms and preferably a linear or branched alkyl group having 1 to 5 carbon atoms; R₆ represents a hydrogen atom or a linear, branched or cyclic alkyl group having 1 to 6 carbon atoms and preferably a hydrogen atom or a linear or branched alkyl group having 1 to 3 carbon atoms; and X represents a halogen atom, with a bromine atom being most preferred as the halogen atom, while taking into consideration the reactivity.

Specific examples of the foregoing N-alkylpyrazolium halides and N,N′-dialkyl-pyrazolium halides include 1-methylpyrazolium chloride, 1-methylpyrazolium bromide, 1-propylpyrazolium chloride, 1-propyl pyrazolium bromide, 1-butylpyrazolium chloride, 1-butylpyrazolium bromide, 1-hexylpyrazolium chloride, 1-hexylpyrazolium bromide, 1-methyl-2-ethyl-pyrazolium chloride, 1-methyl-2-ethylpyrazolium bromide, 1-methyl-2-propylpyrazolium chloride, 1-methyl-2-propylpyrazolium bromide, 1-propyl-2-methylpyrazolium chloride, 1-propyl-2-methyl pyrazolium bromide, 1-butyl-2-methylpyrazolium chloride, 1-butyl-2-methylpyrazolium bromide, 1-hexyl-2-methylpyrazolium chloride, 1-hexyl-2-methylpyrazolium bromide, 1,2-dimethylpyrazolium chloride, 1,2-dimethylpyrazolium bromide, 1,2-di-ethylpyrazolium chloride and 1,2-di ethylpyrazolium bromide.

The N-alkylpyrrolidinium halides and N,N-dialkyl-pyrrolidinium halides used in the present invention as the compound (B) are, for instance, those represented by the following general formula (IV);

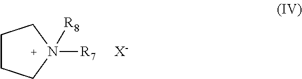

In the formula, R₇ represents a hydrogen atom or a linear, branched or cyclic alkyl group having 1 to 12 carbon atoms and preferably a linear or branched alkyl group having 1 to 5 carbon atoms, R₈ represents a hydrogen atom or a linear, branched or cyclic alkyl group having 1 to 6 carbon atoms and preferably a hydrogen atom or a linear or branched alkyl group having 1 to 3 carbon atoms, provided that R₇ and R₈ do not simultaneously represent hydrogen atoms, and X represents a halogen atom, with a bromine atom being most preferred as the halogen atom, while taking into consideration the reactivity.

Specific examples of the foregoing N-alkylpyrrolidinium halides and N,N-dialkyl-pyrrolidinium halides include 1-methylpyrrolidinium chloride, 1-methylpyrrolidinium bromide, 1,1-dimethylpyrrolidinium chloride, 1-ethyl-1-methylpyrrolidinium chloride, 1-ethylpyrrolidinium chloride, 1-propyl-pyrrolidinium chloride, 1-methyl-1-propylpyrrolidinium chloride, 1-butyl-1-methylpyrrolidinium chloride, 1-ethyl-1-propylpyrrolidinium chloride, 1-methyl-1-hexylpyrrolidinium chloride, 1-butylpyrrolidinium chloride, and 1-ethyl-1-methylpyrrolidinium chloride.

Moreover, the compound (B) may be a mixture of at least two kinds of compounds selected from the foregoing N-alkylpyridinium halides, N-alkylimidazolium halides, N,N′-dialkyl-imidazolium halides, N-alkyl-pyrazolium halides, N,N′-dialkyl-pyrazolium halides, N-alkylpyrrolidinium halides and N,N-dialkyl-pyrrolidinium halides and further the compound (B) may be a mixture of at least two kinds of these compounds whose halogen atoms are different from one another.

In the present invention, the ratio of the molar number of the aluminum halide (A) to that of the compound (B) preferably ranges from 1:1 to 3:1 and more preferably 2:1. The use of these components in such a molar ratio specified above would permit the prevention of the occurrence of any reaction which may be suspected to be the decomposition of pyridinium, imidazolium, pyrazolium or pyrrolidinium cations and likewise permit the prevention of the deterioration of the plating bath and the prevention of the occurrence of any insufficient plating due to the increase in the viscosity of the plating bath.

The zirconium halide (C) used in the present invention is one represented by the general formula: ZrX₄, wherein X represents a halogen atom such as a fluorine, chlorine, bromine or iodine atom, with chlorine atom being preferably used in the present invention from the viewpoint of the easy handling ability thereof.

The concentration of the zirconium halide in the plating bath of the present invention preferably ranges from 4×10⁻⁴ to 4×10⁻¹ mole/L and more preferably 4×10⁻³ to 2×10⁻¹ mole/L. The use of the zirconium halide in the plating bath in such a concentration specified above would permit the setting of the rate of the co-deposition of Zr in the resulting Al—Zr—Mn alloy plated film at a level falling within an appropriate range and also permit the inhibition of any deposition thereof as a black powdery substance.

The manganese halide (D) used in the present invention is one represented by the following general formula: MnX₂, wherein X represents a halogen atom such as a fluorine, chlorine, bromine or iodine atom, with chlorine atom being preferably used in the present invention from the viewpoint of the easy handling ability thereof.

The concentration of the manganese halide in the plating bath of the present invention preferably ranges from 8×10⁻⁴ to 8×10⁻¹ mole/L, more preferably 8×10⁻³ to 4×10⁻¹ mole/L and further preferably 8×10⁻³ to 8×10⁻² mole/L. The use of the manganese halide in the plating bath in such a concentration specified above would permit the setting of the rate of the co-deposition of Mn in the resulting Al—Zr—Mn alloy plated film at a level falling within an appropriate range and also permit the inhibition of any deposition thereof as a black powdery substance.

The electric Al—Zr—Mn alloy plating bath according to the present invention may further comprise (E) an aromatic hydrocarbon solvent in an amount of less than 50% by volume. The aromatic hydrocarbon solvent (E) is not restricted to any particular one inasmuch as it is a non-aqueous aromatic solvent which is soluble in a molten salt and which never results in the reduction of the electric conductivity of the molten salt. Examples of the aromatic hydrocarbon solvent (E) include benzene, toluene, xylene, ethylbenzene, cumene, tetralin, mesitylene, hemimellitene, and pseudocumene. Among them, preferably used herein include benzene, toluene and xylene and the most preferably used herein is toluene among others. Moreover, the concentration of such an aromatic hydrocarbon solvent to be incorporated into the plating bath is preferably less than 50% by volume, the concentration thereof more preferably ranges from 1 to 50% by volume, and further preferably 5 to 10% by volume. If the aromatic hydrocarbon solvent is used in an amount falling within the range specified above, the throwing power of the resulting plating bath is improved, the use of the aromatic solvent in such an amount would likewise permit the formation of a uniform electro-plated layer. The use of the aromatic hydrocarbon solvent never leads to any reduction of the electrical conductivity of the bath and does not increase the risk of catching fire.

The electric Al—Zr—Mn alloy plating bath according to the present invention may further comprise (F) one or at least two kinds of organic polymers selected from the group consisting of styrenic polymers and aliphatic diene-derived polymers. Specific examples of the styrenic polymers used as the organic polymers (F) in the present invention are styrenic homopolymers of styrenic monomers such as styrene, a -methylstyrene, vinyltoluene, and m-methylstyrene, copolymers of these styrenic monomers and copolymers of these styrenic monomers and other polymerizable vinylic monomers. Examples of the foregoing vinylic monomers include maleic anhydride, maleic acid, acrylic acid, methacrylic acid, methyl methacrylate, glycidyl methacrylate, itaconic acid, acrylamide, acrylonitrile, maleimide, vinyl pyridine, vinyl carbazole, acrylic acid esters, methacrylic acid esters, fumaric acid esters, vinyl ethyl ether, and vinyl chloride. Among them, α, β-unsaturated carboxylic acids having 3 to 10 carbon atoms or alkyl (having 1 to 3 carbon atoms) esters thereof are preferable.

In addition, examples of the aliphatic diene-derived polymers used as the organic polymers (F) in the present invention include polymers derived from monomers such as butadiene, isoprene and pentadiene. Among them, polymers each having a branched chain in the form of a 1,2- or 3,4-structure, or copolymers of these monomers with other polymerizable vinylic monomers are preferable. Examples of the foregoing vinylic monomers include those described above in connection with the foregoing styrenic polymers.

The weight average molecular weight of the organic polymer (F) preferably ranges from 200 to 80,000. In particular, polystyrenes and poly(α-methylstyrenes) each having a low to medium weight average molecular weight on the order of 300 to 5,000 are most preferably used herein because of its excellent solubility in the molten salt. The concentration thereof in the resulting plating bath preferably ranges from 0.1 to 50 g/L and more preferably 1 to 10 g/L. The use of the organic polymer (F) in such a concentration specified above would permit the prevention of the formation of any dendritic deposit, ensure the achievement of the desired surface-smoothening effect and likewise permit the prevention of the occurrence of any burning of the plated film.

The electric Al—Zr—Mn alloy-plating bath according to the present invention may further comprise brightening agent (G). The brightening agent (G) may be, for instance, one or at least two kinds of compounds selected from the group consisting of aliphatic aldehydes, aromatic aldehydes, aromatic ketones, nitrogen atom-containing unsaturated heterocyclic compounds, hydrazide compounds, sulfur atom-containing heterocyclic compounds, aromatic hydrocarbons each carrying a sulfur atom-containing substituent, aromatic carboxylic acids and derivatives thereof, aliphatic carboxylic acids each having a double bond and derivatives thereof, acetylene alcohol compounds and trifluoro-chloro-ethylenic resins.

The aliphatic aldehyde may be, for instance, those having 2 to 12 carbon atoms and specific examples thereof are tribromo-acetaldehyde, metaldehyde, 2-ethylhexylaldehyde, and lauryl-aldehyde.

The aromatic aldehyde may be, for instance, those each having 7 to 10 carbon atoms and specific examples thereof are o-carboxy-benzaldehyde, benzaldehyde, o-chloro-benzaldehyde, p-tolualdehyde, anisaldehyde, p-di-methylamino-benzaldehyde, and terephthaldehyde.

The aromatic ketones may be, for instance, those each having 8 to 14 carbon atoms and specific examples thereof are benzalacetone, benzo-phenone, acetophenone and terephthaloyl benzyl chloride.

The nitrogen atom-containing unsaturated heterocyclic compound may be, for instance, those each having 3 to 14 carbon atoms and specific examples thereof are pyrimidine, pyrazine, pyridazine, s-triazine, quinoxaline, phthalazine, 1,10-phenanthroline, 1,2,3-benzotriazole, acetoguanamine, cyanuric chloride, and imidazole-4-acrylic acid.

The hydrazide compound may be, for instance, maleic acid hydrazide, isonicotinic acid hydrazide, and phthalic acid hydrazide.

The sulfur atom-containing heterocyclic compound may be, for instance, those each having 3 to 14 carbon atoms and specific examples thereof are thiouracil, thionicotinic acid amide, S-trithiane, 2-mercapto-4,6-dimethyl-pyrimidine.

The aromatic hydrocarbons each carrying a sulfur atom-containing substituent may be, for instance, those each having 7 to 20 carbon atoms and specific examples thereof include thiobenzoic acid, thioindigo, thioindoxyl, thioxanthene, thioxanthone, 2-thiocoumarin, thiocresol, thiodiphenyl amine, thionaphthol, thiophenol, thiobenzamide, thiobenzanilide, thio-benzaldehyde, thio-naphthene-quinone, thio-naphthene, and thio-acetanilide.

The aromatic carboxylic acids and derivatives thereof may be, for instance, those each having 7 to 15 carbon atoms and derivatives thereof, and specific examples thereof are benzoic acid, terephthalic acid, and ethyl benzoate.

The aliphatic carboxylic acids each having a double bond and derivatives thereof may be, for instance, those each having a double bond and 3 to 12 carbon atoms and derivatives thereof, and specific examples thereof are acrylic acid, crotonic acid, methacrylic acid, acrylic acid-2-ethylhexyl, and methacrylic acid-2-ethylhexyl.

The acetylene alcohol compound may be, for instance, propargyl alcohol.

The fluororesin may be, for instance, trifluoro-chloro-ethylenic resins each having an average molecular weight ranging from 500 to 1,300.

The concentration of the brightening agent (G) in the plating bath preferably ranges from 0.001 to 0.1 mole/L and more preferably 0.002 to 0.02 mole/L. If the brightening agent (G) is used in the electric Al—Zr—Mn alloy-plating bath of the present invention in such a concentration specified above, the achievement of an intended smoothening effect can be ensured and there is not observed the formation of any black smut-like deposit even when the plating is carried out at a high current density.

The electric Al—Zr—Mn alloy-plating bath according to the present invention may likewise comprise two kinds of components, in combination, selected from the group consisting of an aromatic hydrocarbon solvent (E), an organic polymer (F) and a brightening agent (G) in addition to the foregoing essential components and in this respect, the plating bath of the present invention may likewise comprise all of the foregoing three kinds of components simultaneously.

An example of the plating method which makes use of the electric Al—Zr—Mn alloy-plating bath according to the present invention is an electro-plating method. The electro-plating method can be carried out using a direct current or a pulsed current, but the use of a pulsed current is particularly preferable. In this connection, it is preferred to use a pulsed current under the following conditions: a duty ratio (ON/OFF ratio) preferably ranging from 1:2 to 2:1 and most preferably 1:1; an ON time ranging from 5 to 20 ms; and an OFF time ranging from 5 to 20 ms, since the electrodeposited particles thus formed are densified and smoothened. The bath temperature used herein usually ranges from 25 to 120° C. and preferably 50 to 80° C. The current density as an electrolysis condition in general ranges from 0.1 to 15 A/dm² and preferably 0.5 to 5 A/dm². In this respect, the electric Al—Zr—Mn alloy-plating bath according to the present invention is safe even when it is brought into contact with oxygen or moisture, but the electro-plating method is desirably carried out in a dry, oxygen-free atmosphere (for instance, in a dry nitrogen gas atmosphere or dry argon gas atmosphere) for the purpose of maintaining the stability of the plating bath and of ensuring the desired quality of the resulting plated layer. Moreover, when putting the electric plating procedure into practice, it is desirable that the bath liquid is stirred or/and the subject to be plated is oscillated. For instance, the current density can further be increased by stirring the bath liquid through the use of a jet stream or the application of ultrasonic waves.

In this respect, however, when plating a part having a complicated shape, it is desirable to omit the stirring operation or weaken the strength of the stirring and to carry out the plating at a low cathode current density on the order of 0.5 to 1 A/dm² for a long period of time for the improvement of the throwing power. The anode to be used herein may desirably be a combination of Al, Zr and Mn plates or it is also possible to use an Al plate or an insoluble anode. In this connection, however, it is necessary to maintain the composition of the bath liquid to a desired constant level by the supplementation of, for instance, an aluminum halide, a zirconium halide and a manganese halide.

The use of the electric Al—Zr—Mn alloy-plating bath according to the present invention would permit the application of a densified and smooth Al—Zr—Mn alloy-plated film onto the surface of a variety of metals or ceramics (basis materials) such as iron, zinc and ceramics. In this respect, it is preferred to subject the basis material to a pre-treatment prior to the plating since such a pre-treatment may further improve the adhesion between the foregoing basis material and the plated film according to the present invention. Examples of such a pre-treatment preferably used herein include an Ni-plating process as a treatment of the surface of the basis material, a treatment of the basis material to be plated by the immersion of the same in a solution having a composition identical to that of the plating bath of the present invention, or an anodic electrolysis of the same at an electric current preferably ranging from 0.5 to 5 A/dm² for a time ranging from 30 seconds to 10 minutes.

Regarding the Al—Zr—Mn alloy-plated film obtained using the electric Al—Zr—Mn alloy plating bath according to the present invention, the rate of the total co-deposition of Zr and Mn is preferably in the range of from 2 to 40% by mass (in this respect, the rate of co-deposition of Al ranges from 98 to 60% by mass), more preferably 3 to 35% by mass and most preferably 15 to 35% by mass. If the rate of total co-deposition of Zr and Mn is set at a level specified above, the corrosion resistance of the resulting Al—Zr—Mn alloy-plated film is considerably improved. Moreover, in the Al—Zr—Mn alloy plated film, the rate of Zr-co-deposition preferably ranges from 1 to 39% by mass, more preferably 5 to 30% by mass, further preferably 10 to 30% by mass and most preferably 10 to 25% by mass. Furthermore, the rate of Mn-co-deposition in the alloy-plated film preferably ranges from 1 to 39% by mass, more preferably 2 to 25% by mass and most preferably 3 to 20% by mass. Thus, the Al—Zr—Mn alloy-plated layer prepared according to the present invention permits the improvement of the anti-corrosive properties of an iron-based basis material and in particular, it can control the generation of any red rust of the material at the cracked portions thereof and can thus substantially improve the corrosion resistance thereof.

The thickness of the Al—Zr—Mn alloy-plated film obtained through the use of the electric Al—Zr—Mn alloy-plating bath according to the present invention usually ranges from 2 to 40 μm and preferably 5 to 15 μm.

### EXAMPLES

The present invention will be described in detail below with reference to the following non-limiting Examples and Comparative examples.

### Examples 1 to 4

Toluene, as an aromatic hydrocarbon solvent was blended, in an amount of 35% by volume, with a bath prepared by melt blending AlCl₃ and 1-methyl-3-propylimidazolium bromide at a molar ratio of 2:1 and then manganese chloride and zirconium chloride were added to the resulting blend in each corresponding amount as specified in the following Table 1 to thus give an electric Al—Zr—Mn alloy-plating bath. Then an iron plate (thickness: 0.5 mm) used as a cathode was subjected to pretreatments. More specifically, the iron plate was degreased with an alkali, washed through the alkali-electrolysis, then washed with an acid, washed with water and then with ethyl alcohol and finally dried. Using the foregoing iron plate as a cathode and an aluminum plate (purity: 99.9%) as an anode, these electrodes were immersed in the foregoing electric Al—Zr—Mn alloy-plating bath maintained at 60° C. in a dry nitrogen gas atmosphere for 5 minutes and then the Al—Zr—Mn alloy-plating was carried out using a pulsed current (duty ratio=1:1; ON time: 10 ms; and OFF time: 10 ms) in the same alloy-plating bath used above. In this respect, the plating bath was vigorously stirred using a stirrer. In these Examples, the resulting electric Al—Zr—Mn alloy-plated films each were inspected for the rates of the co-deposited Mn and Zr (%), and the corrosion resistance. The results thus obtained in such evaluation procedures as well as the concentrations, in the bath, of manganese chloride and zirconium chloride and the conditions used for the electrolysis are summarized in the following Table 1.

TABLE 1
(Thickness of film: 8 μm)

| Ex. | MnCl₂ | | Current Den. | |
|---|---|---|---|---|
| No. | (mole/L) | ZrCl₄ (mole/L) | (A/dm²) | Time (min) |
| 1 | 0.04 | 0.02 | 1 | 120 |
| 2 | 0.04 | 0.02 | 2 | 60 |
| 3 | 0.008 | 0.02 | 1 | 120 |
| 4 | 0.02 | 0.02 | 2 | 60 |

| | | | Time Reqd. for the form. of |
|---|---|---|---|
| Ex. | Rate of Mn- | Rate of Zr- | Red Rust on SST (hr); |
| No. | co-dep. (%) | co-dep. (%) | Usual sur./Cracked portion |
| 1 | 8 | 20 | 1500/1000 |
| 2 | 10 | 24 | 1500/800 |
| 3 | 3 | 20 | 1500/1500 |
| 4 | 6 | 25 | 1500/1500 |

### Examples 5 to 8

There were added 0.02 mole/L of manganese chloride and 0.015 mole/L of zirconium chloride to a bath prepared by melt blending AlCl₃ and 1-methyl-3-propylimidazolium bromide at a molar ratio of 2:1. Further, a variety of additives as specified in the following Table 2 were added to the resulting bath in amounts likewise specified in Table 2 to thus give each corresponding electric Al—Zr—Mn alloy plating bath. Then an iron plate (thickness: 0.5 mm) used as a cathode was subjected to pretreatments. More specifically, the iron plate was degreased with an alkali, washed through the alkali-electrolysis, then washed with an acid, washed with water and then with ethyl alcohol and finally dried. Using the foregoing iron plate as a cathode and an aluminum plate (purity: 99.9%) as an anode, these electrodes were immersed in the foregoing electric Al—Zr—Mn alloy-plating bath maintained at 50° C. in a dry nitrogen gas atmosphere for 5 minutes and then the Al—Zr—Mn alloy-plating was carried out using a direct current in the same alloy-plating bath used above. In this respect, the plating bath was stirred using a stirrer. In these Examples, the resulting electric Al—Zr—Mn alloy-plated films each were inspected for the rates of the co-deposited Mn and Zr (%), and the corrosion resistance. The results thus obtained in such evaluation procedures as well as the concentrations of the additives incorporated into the plating bath and the conditions used for the electrolysis are summarized in the following Table 2.

TABLE 2
(Thickness of film: 8 μm)

| | | | | Rate of Mn- | Rate of Zr- | Time reqd. for the |
|---|---|---|---|---|---|---|
| Ex. | | Cur. Den. | Time | co-dep. | co-dep. | form. of red rust on |
| No. | Additive (g/L) | A/dm² | (min) | (%) | (%) | SST (hr), usual sur. |
| 5 | (F) Polystyrene¹⁾ | 2 | 40 | 10 | 25 | 1500 |
| | 2.5 g/L | | | | | |
| 6 | (G) 1,10-phenanthroline, | 2 | 40 | 10 | 25 | 1500 |
| | 0.25 g/L | | | | | |
| 7 | (G) Isonicotinic acid | 1 | 80 | 5 | 20 | 1500 |
| | hydrazide, 0.2 g/L | | | | | |
| 8 | (G) Thiouracil, 0.1 g/L | 1 | 80 | 5 | 20 | 1500 |

¹⁾Polystyrene: Piccolastic A75 (MW: 1300), available from Eastman Chemical Co., Ltd.

### Examples 9 to 11

The followings are Examples in which both solvent and additive are not used in the alloy-plating bath.

There were added, in amounts as specified in the following Table 3, manganese chloride and zirconium chloride to a plating bath prepared by melt blending AlCl₃ and 1-methyl-3-propyl-imidazolium bromide at a molar ratio of 2:1 to thus give each corresponding electric Al—Zr—Mn alloy-plating bath. Then an iron plate (thickness: 0.5 mm) used as a cathode was subjected to pretreatments. More specifically, the iron plate was degreased with an alkali, washed through the alkali-electrolysis, then washed with an acid, washed with water and then with ethyl alcohol and finally dried. Using the foregoing iron plate as a cathode and an aluminum plate (purity: 99.9%) as an anode, these electrodes were immersed in the foregoing electric Al—Zr—Mn alloy-plating bath maintained at 80° C. in a dry nitrogen gas atmosphere for 5 minutes and then the Al—Zr—Mn alloy-plating was carried out using a pulsed current (duty ratio=1:1; ON time: 10 ms; and OFF time: 10 ms) in the same plating bath used above. In this respect, the plating bath was gently stirred using a stirrer. The resulting electric Al—Zr—Mn alloy-plated films each were inspected for the rates of the co-deposited Mn and Zr (%) and the corrosion resistance. The results thus obtained in such evaluation procedures are summarized in the following Table 3 together with the concentrations of Mn and Zr in the plating bath and the conditions for the electrolysis.

TABLE 3
(Thickness of Film: 8 μm)

| Ex. | MnCl₂ | ZrCl₄ | Current Density | Time |
|---|---|---|---|---|
| No. | (mole/L) | (mole/L) | (A/dm²) | (min) |
| 9 | 0.04 | 0.004 | 1 | 100 |
| 10 | 0.04 | 0.008 | 1 | 100 |
| 11 | 0.08 | 0.008 | 2 | 50 |
| 12 | 0.16 | 0.016 | 1 | 100 |

| | | | Time Regd. for the form. of |
|---|---|---|---|
| Ex. | Rate of Mn- | Rate of Zr- | Red Rust on SST (hr); |
| No. | co-dep. (%) | co-dep. (%) | Usual sur./Cracked portion |
| 9 | 8.5 | 13 | 1500 |
| 10 | 12 | 19 | 1500 |
| 11 | 18 | 11 | 1500 |
| 12 | 20 | 15 | 1500 |

### Comparative Examples 1 to 3

There were added a variety of additives as specified in the following Table 4, in amounts likewise specified in Table 4, to a plating bath prepared by melt blending AlCl₃ and 1-methyl-3-propyl-imidazolium bromide at a molar ratio of 2:1 to thus give each corresponding electric Al-plating bath. Then an iron plate (thickness: 0.5 mm) used as a cathode was subjected to pretreatments. More specifically, the iron plate was degreased with an alkali, washed through the alkali-electrolysis, then washed with an acid, washed with water and then with ethyl alcohol and finally dried. Using the foregoing iron plate as a cathode and an aluminum plate (purity: 99.9%) as an anode, these electrodes were immersed in the foregoing electric Al-plating bath maintained at 50° C. in a dry nitrogen gas atmosphere for 5 minutes and then the Al-plating was carried out using a direct current in the same plating bath used above. In this respect, the plating bath was stirred using a stirrer. The resulting electric Al-plated films were inspected for the corrosion resistance. The results thus obtained in such evaluation procedure are summarized in the following Table 4 together with the concentrations of the additives used in the plating bath and the conditions for the electrolysis.

TABLE 4
(Thickness of Film: 8 μm)

| | | | | Time Reqd. for the |
|---|---|---|---|---|
| Comp. | | Current | | form. of Red Rust on |
| Ex. | | Den. | Time | SST (hr); Usual |
| No. | Additive | (A/dm²) | (min) | sur./Cracked portion |
| 1 | None | 4 | 20 | 120/120 |
| 2 | (F) Polystyrene¹⁾, 5 g/L | 4 | 20 | 480/480 |
| 3 | (G) 1,10-Phenanthroline, | 4 | 20 | 480/480 |
| | 0.5 g/L | | | |

¹⁾: Polystyrene: Piccolastic A75 (MW: 1300), available from Eastman Chemical Co., Ltd.

### Comparative Examples 4 to 6

Manganese chloride was added, in amounts specified in the following Table 5, to a plating bath prepared by melt blending AlCl₃ and 1-methyl-3-propyl-imidazolium bromide at a molar ratio of 2:1 to thus give each corresponding electric Al—Mn alloy-plating bath. Then an iron plate (thickness: 0.5 mm) used as a cathode was subjected to pretreatments. More specifically, the iron plate was degreased with an alkali, washed through the alkali-electrolysis, then washed with an acid, washed with water and then with ethyl alcohol and finally dried. Using the foregoing iron plate as a cathode and an aluminum plate (purity: 99.9%) as an anode, these electrodes were immersed in the foregoing electric Al—Mn alloy-plating bath maintained at 50° C. in a dry nitrogen gas atmosphere for 5 minutes and then the Al—Mn alloy-plating was carried out using a direct current in the same plating bath used above. In this respect, the plating bath was stirred using a stirrer. The resulting electric Al—Mn alloy-plated films each were inspected for the rate of the co-deposited Mn (%) and the corrosion resistance. The results thus obtained in such evaluation procedures are summarized in the following Table 5 together with the concentrations of Mn in the plating bath and the conditions for the electrolysis.

TABLE 5
(Thickness of Film: 8 μm)

| | | | | | Time Reqd. for the |
|---|---|---|---|---|---|
| Comp. | MnCl² | Current | | Rate of | form. of Red Rust |
| Ex. | (mole/ | Den. | Time | Mn-co- | on SST (hr); Usual |
| No. | L) | (A/dm²) | (min) | dep. (%) | sur./Cracked portion |
| 4 | 0.04 | 4 | 20 | 20 | 1500/24 |
| 5 | 0.08 | 4 | 20 | 25 | 1500/24 |
| 6 | 0.16 | 4 | 20 | 30 | 1500/24 |

In the foregoing Examples and Comparative Examples, the rates of co-deposited Mn and Zr (%), the thickness of each alloy-plated film and the time required for the formation of red rust on SST were determined according to the methods specified below:

### (Method for the Determination of Rate of Co-Deposited Metal (%) and Thickness of Plated Film)

The rates of the co-deposited Mn and Zr (%) and the thickness of each resulting Al-alloy-plated film were determined using an X-ray fluorescence spectrometer (Micro-Element Monitor SEA5120 available from SII-Nanotechnology Co., Ltd.).

### (Method for the Determination of Time Required for Generating Red Rust on SST)

The time required for the generation of red rust on SST was determined according to the salt spray test (JIS Z2371).

1. An electric Al—Zr—Mn alloy-plating bath comprising (A) an aluminum halide; (B) one or at least two kinds of compounds selected from the group consisting of N-alkylpyridinium halides, N-alkylimidazolium halides, N,N′-dialkyl-imidazolium halides, N-alkylpyrazolium halides, N,N′-dialkyl-pyrazolium halides, N-alkylpyrrolidinium halides and N,N-dialkyl-pyrrolidinium halides; (C) a zirconium halide; and (D) a manganese halide, in which the molar ratio of the aluminum halide (A) to the compound (B) ranges from 1:1 to 3:1.

2. The electric Al—Zr—Mn alloy-plating bath as set forth in claim 1, wherein the concentration of the zirconium halide (C) in the plating bath ranges from 4×10⁻¹ to 4×10⁻¹ mole/L and that of the manganese halide (D) in the plating bath ranges from 8×10⁻¹ to 8×10⁻¹ mole/L.

3. The electric Al—Zr—Mn alloy-plating bath as set forth in claim 1, wherein the plating bath further comprises (E) an aromatic hydrocarbon solvent in a concentration of less than 50% by volume.

4. The electric Al—Zr—Mn alloy-plating bath as set forth in claim 1, wherein the plating bath further comprises (F) one or at least two kinds of organic polymers selected from the group consisting of styrenic polymers and aliphatic diene-derived polymers in a concentration ranging from 0.1 to 50 g/L.

5. The electric Al—Zr—Mn alloy-plating bath as set forth in claim 1, wherein the plating bath further comprises (G) a brightening agent in a concentration ranging from 0.001 to 0.1 mole/L.

6. An electro-plating method characterized by the use of an electric Al—Zr—Mn alloy-plating bath as set forth in claim 1.

7. The electro-plating method as set forth in claim 6, wherein the electric plating is carried out using a pulsed current and/or under the compulsory stirring conditions.

8. An Al—Zr—Mn alloy-plated film characterized in that the rate of the total co-deposition of Zr and Mn in the alloy-deposited film is in the range of from 2 to 40% by mass.

9. An Al—Zr—Mn alloy-plated film characterized in that the rate of Zr-co-deposition in the alloy-plated film ranges from 1 to 39% by mass and that the rate of Mn-co-deposition in the alloy-plated film ranges from 1 to 39% by mass.

10. An Al—Zr—Mn alloy-plated film as set forth in claim 9 wherein the alloy-plated film is applied onto the surface of an iron-based basis material.
